(19) United States
(12) Patent Application Publication
(10) Pub. No.: US 2015/0300075 A1
(43) Pub. Date: Oct. 22, 2015

(54) DOOR FOR POPPER CABINET

(71) Applicant: Gold Medal Products Company, Cincinnati, OH (US)

(72) Inventor: Corey A. Lyons, Cincinnati, OH (US)

(21) Appl. No.: 14/552,615

(22) Filed: Nov. 25, 2014

Related U.S. Application Data
(60) Provisional application No. 61/909,591, filed on Nov. 27, 2013.

(51) Int. Cl. E06B 3/50; A23L 1/18; A47B 81/00

(52) U.S. Cl. CPC E06B 3/509; E06B 3/5072; A47B 81/00; A23L 1/1812

(57) ABSTRACT

A popcorn popper includes a cabinet with a door selectively closing a cabinet opening. The door swings 90 degrees to an open position then is translated or retracted in a direction parallel to the door and alongside the cabinet without rotation over an adjacent counter. Door mounting brackets and operatively associated slide tracks are disclosed.

### PRIORITY CLAIM

Applicant claims the benefit of the filing date, Nov. 27, 2013, of prior U.S. Provisional Patent Application Ser. No. 61/909,591, which application is incorporated herein by express reference.

### FIELD OF THE INVENTION

This invention relates to popcorn popper cabinets and more particularly to doors for such cabinets.

### BACKGROUND OF THE INVENTION

Popcorn popper cabinets typically include at least a top, back, two sides and an open front closed off by one or two doors which can be swung open to allow access to the cabinet interior for loading unpopped kernels into a popping kettle or to accommodate removal of popped popcorn. Current door designs include one or more doors hinged at edges near front corners of the cabinet. These allow popper doors to swing open 270 degrees from closed position until they contact the side of the popper. As they swing open, they sweep through an arc over any adjacent counter. This position is advantageous because the opened doors are out of the way, disposed in close proximity generally parallel to the side of the popper cabinet and do not project onto or take up any valuable space in the concession stand. When another piece of equipment is placed next to a popper however, it obstructs opening motion or swinging of the door and does not allow the door to completely rotate open next to the popper. As a result, the door remains protruding from the popper at its hinge point into the adjacent concession space until the doors are again closed. This either causes the door to project into the concession space, and prevents the open door from opening fully into position alongside the cabinet. If full opening is required, counter space adjacent the cabinet must be clear and unused to allow the door to swing fully open. This diminishes usable counter space adjacent the popper cabinet.

It is accordingly an objective of the invention to provide a popper cabinet with doors which can be opened and moved to a stored or retracted position alongside or parallel to the cabinet side, and while remaining operably connected to the popper cabinet at the same time do not require the necessary swing arc across the adjacent concession space as in prior known cabinets to open the doors fully.

### SUMMARY OF THE INVENTION

The present invention allows doors to be tucked away next to the popper cabinet even when a piece of equipment or other item is located adjacent to the popper. The doors, however, are present and ready for immediate use and any health inspection, while adjacent counter space can be used for other items.

A preferred embodiment of the invention allows popper doors to swing open about 90 degrees from their closed position across the cabinet front to an open position that is substantially parallel to the side of the popper but with doors protruding forwardly from the front of the popper. The doors are then slideable in a direction parallel to the side of the popper, along the sides of the popper until they oriented in a stored open position along the respective sides of the popper but no longer protrude from the front of the popper cabinet. No swinging past the 90 degree arc is required and the opening of the doors do not swing across adjacent counter space.

### BRIEF DESCRIPTION OF THE DRAWINGS

These and other advantages will be readily apparent from the following detailed description of a preferred embodiment of the invention and from the drawings in which:

FIG. 1 is an isometric illustration of a popcorn popper cabinet provided with right and left front doors in closed position according to one embodiment of the invention;

FIG. 2 is an isometric illustration of the cabinet of FIG. 1 (in phantom lines for clarity) and showing the left and right side doors swinging 90 degrees from their position in FIG. 1 to an open position; and

FIG. 3 is an isometric illustration of the cabinets of FIGS. 1 and 2 showing the final stored open position of the doors alongside side walls of the cabinet, with the cabinet illustrated in phantom lines for clarity.

### DETAILED DESCRIPTION OF THE INVENTION

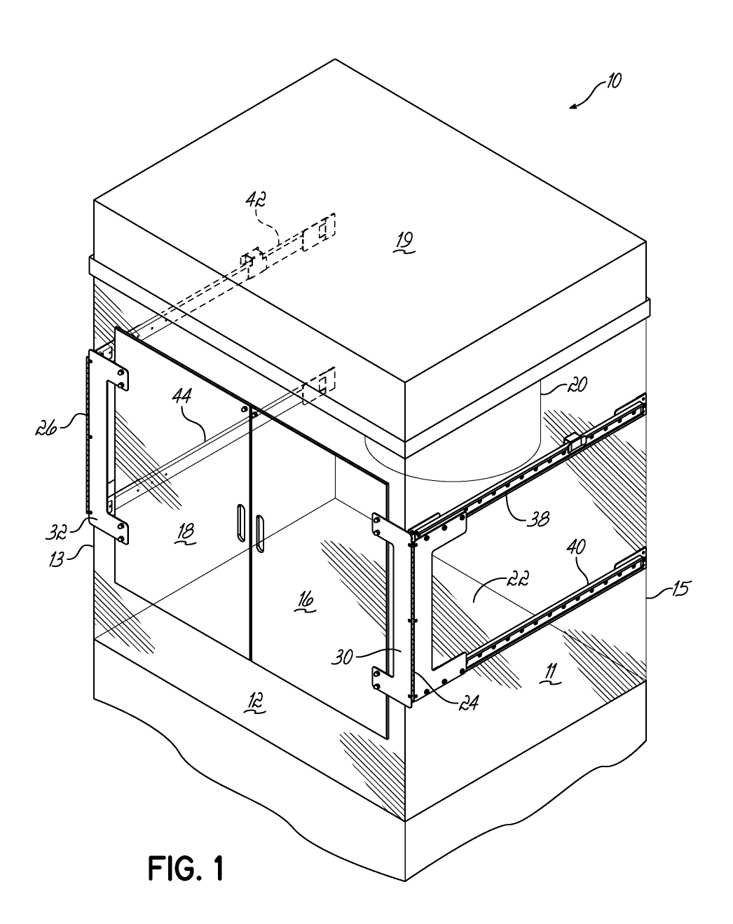

Turning to the drawings it will be appreciated that FIGS. 1-3 illustrate a preferred embodiment of the invention.

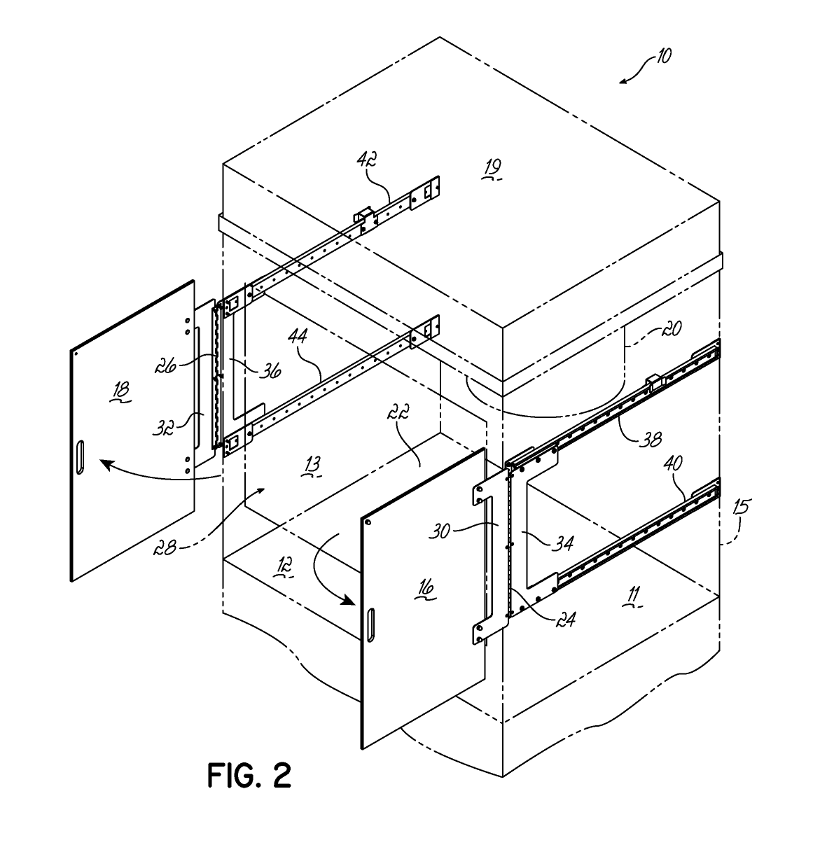

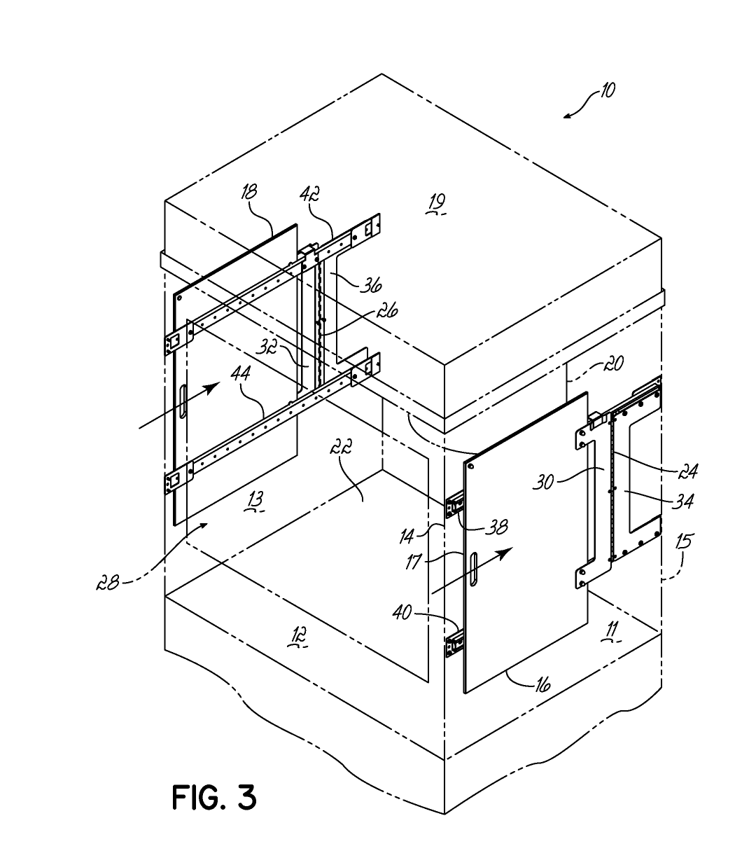

In FIG. 1 a popcorn popper cabinet 10 is illustrated and has a left side wall 11, front wall 12, right side wall 13, rear wall 15, left front door 16 and right front door 18. The cabinet encloses a popping kettle 20 in its upper regions under a cabinet top 19 and a popcorn bin 22 in its lower regions as shown. Kettle 20 is shown only in phantom lines in FIGS. 2-3 for clarity. Preferably but not necessarily, the cabinet front and side walls at least are transparent 90 degrees.

Doors 16, 18 are hinged at left and right hinge axes 24, 26 and can swing open to provide access to cabinet 10, through open front 28. For clarity in FIGS. 2 and 3, cabinet 10 is shown therein only in phantom.

It will be appreciated that each door 16, 18 is pivotally secured to cabinet 10 by a respective door bracket 30, 32 hinged to a slide bracket 34,36, respectively.

Slide brackets 34,36 are slidably received by respective upper and lower slide tracks 38, 40 and 42, 44 mounted to the respective cabinet sides 11, 13 and perhaps as best seen in FIG. 2. In this FIG. 2, doors 16, 18 are partially swung open 90 degrees from their closed position of FIG. 1.

FIG. 3 illustrates doors 16, 18 positioned generally parallel to cabinet sides 11, 13 respectively, having been slid back along sides 11, 13 to a fully open and stored position. At this point door bracket 30 and slide bracket 34 are generally parallel to each other, to the door 16, and to side 11, having slid from the FIG. 2 position. Likewise, door 18, door bracket 32, slide bracket 36 and cabinet side wall 18 are proximate parallel to each other. So the doors 16, 18 are opened by swinging 90 degrees from closed position (FIG. 1) to an open position (FIG. 2). From there the doors are slid rearwardly to the stored position as shown in FIG. 3.

In this embodiment and as noted, cabinet 10 is provided with two front doors 16, 18. It will appreciated from the FIGS that doors 16, 18 are substantially mirror images of each other, as are brackets 30,34 on one side and brackets 32, 36 on the other.

It will be appreciated that slide bracket 34 is slidably mounted to upper and lower slide tracks 38, 40. As well, slide bracket 36 is slidably mounted to upper and lower slide tracks 42 44. Moreover, it will be appreciated the brackets 30, 34 mount door 16 and brackets 32,36 mount door 18 so each door can be pushed rearwardly to the stored position of FIG. 3 without swinging past the original 90 degree opening arc, and without interference by the brackets or tracks. Any suitable mechanism, offset brackets or the like providing this function can be used.

It will be appreciated that a popper cabinet according to the invention can be provided with only one door, mounted on one side of the cabinet as described herein, covering an access opening in the front wall, and thus providing the advantages of the invention here described.

Turning now to FIG. 3, door 16 has been slid rearwardly into a retracted stored position, parallel to side 11, with door edge 17 positioned rearwardly of front left cabinet edge 14. Door 18 is similarly positioned on the other side of the cabinet.

While doors 16, 18 are preferably generally parallel to sides 11, 13, they lie generally alongside sides 11, 13 and may be slightly angled with respect thereto, dependent upon the maximum swing arc provided at pivots or hinge axes 24, 26, or other features of the mounting or slide brackets or tracks.

It will be further appreciated that slide brackets 34, 36 are beneficially and operably mounted in any suitable way to slide tracks 38, 40, 42, 44 respectively for sliding therealong, and for pivotally supporting door brackets 30, 32 suitably, as well as doors 16, 18 respectively.

Respective bracket sets each comprise two pivoted brackets 30, 34 and 32, 36 respectively pivoted with respect to each other. Each of slid tracks 38, 40 and 42,44 respectively define a set of slide tracks.

It will be appreciated the doors swing open only about 90 degrees from closed position across the front of the associated cabinet to an open position where they extend forwardly of the cabinet. From there the doors can be stored out of the way by retraction in a direction generally parallel to the respective cabinet sides. No door rotation beyond the original 90 degree opening swing is required so there is no area beside the cabinets which are swept by the door opening from closed position to stored position. Items next to and adjacent the cabinet do not obstruct the door movement from closed position to fully stored position; and the doors are advantageously stored without removal. Counter space otherwise left open due to door opening, can now be advantageously used for items which might otherwise block full door opening.

It will appreciated that as noted and as shown in the FIGS., the doors 16, 18 and sides 11, 13, and front wall 12 rear wall 15 are transparent, however they could be translucent or opaque, and of any suitable material.

Finally, it will be appreciated that other suitable mounting structures providing the described door movements might be advantageously used. For example, slideable tracks might be mounted on the doors with fixed, pivoted brackets mounted on the cabinet sides, in a manner to allow the same door movement as described above. The invention thus contemplates pivoting slide means of either form for rotating then sliding the doors for storage as described above. In any event, in each embodiment, a respective set of brackets is operably connected with a respective set of slide tracks to support a door which can open 90 degrees from a closed position on a cabinet to an open position, and which can then be retracted to a stored position in a direction parallel to the cabinet side.

What is claimed is:

1. Door apparatus for a popcorn popping cabinet having an open front and at least one side wall and including;
a pivoting slide means for pivotally and slidably mounting said door to said cabinet;
said door being pivotally mounted to rotate from a closed position across said open front to an open position providing access to an interior of said cabinet;
said door being slidable in a direction parallel to said door in said open position and to a position alongside a side wall of said cabinet.

2. Door apparatus as in claim 1 wherein said door projects forwardly from said cabinet when in said open position.

3. Door apparatus as in claim 2 wherein said door projects in a direction parallel to said side wall.

4. Door apparatus as in claim 3 wherein said door pivots 90 degrees from said closed position to said open position.

5. Door apparatus as in claim 1 wherein said pivoting slide means includes slide tracks mounted on said cabinet side wall.

6. Door apparatus as in claim 5 further including brackets mounted on said cabinet door and supporting said door on a slide track.

7. A popcorn popping cabinet having side walls and a front opening and including the combination of:
at least one door covering at least a portion of said front opening;
a set of brackets operatively mounted between said cabinet and said door;
a set of slide tracks operably mounted between said cabinet and said door,
one of said brackets in said set of brackets pivotally mounted with respect to another bracket of said set;
said bracket set slidably mounted with respect to said set of slide tracks,
said door being pivotally and slidably moveable.
